(19) United States
(12) Patent Application Publication
(10) Pub. No.: US 2024/0109485 A1
(43) Pub. Date: Apr. 4, 2024

(54) VEHICLE-AIDED DETECTION SYSTEM

(71) Applicant: Ford Global Technologies, LLC, Dearborn, MI (US)

(72) Inventors: Stuart C. Salter, White Lake, MI (US); Brendan Diamond, Grosse Pointe, MI (US); Mario Anthony Santillo, Canton, MI (US); Keith Weston, Canton, MI (US); David Brian Glickman, Southfield, MI (US)

(73) Assignee: Ford Global Technologies, LLC, Dearborn, MI (US)

(21) Appl. No.: 17/957,346

(22) Filed: Sep. 30, 2022

(51) Int. Cl. B60Q 5/00; B25J 11/00; B25J 13/00; B60J 3/04; B60P 3/00; G06F 3/16; G10L 15/22; H04R 1/08; H04R 3/00

(52) U.S. Cl. CPC B60Q 5/005; B25J 11/005; B25J 13/003; B60J 3/04; B60P 3/00; G06F 3/165; G10L 15/22; H04R 1/08; H04R 3/00; H04R 2499/13

(57) ABSTRACT

A vehicle-aided detection system for a vehicle is provided herein. The vehicle-aided detection system includes an end effector that is movable in an operating environment and coupled to a cargo bed via a robotic arm. A sensor system is configured to detect the end effector and at least one person in the operating environment. A controller is configured to process information received from the sensor system and to determine a physical profile of at least one person. The controller then determines whether user-worn equipment is equipped by the at least one person.

### FIELD OF THE DISCLOSURE

The present disclosure generally relates to a system of a vehicle, and more particularly relates to the detection and monitoring of a vehicle aided operation.

### BACKGROUND OF THE DISCLOSURE

Vehicle-aided operations are commonly conducted near a vehicle. As such, it would be desirable to detect, monitor, and aid such vehicle-aided operations.

### SUMMARY OF THE DISCLOSURE

According to one aspect of the present disclosure, a vehicle-aided detection system for a vehicle includes a body. An end effector is coupled to the body. The end effector is movable in an operating environment. The end effector is operable between a use condition and a non-use condition. A sensor system is configured to detect the end effector and at least one person in the operating environment of the end effector. A controller processes information received from the sensor system. The controller is configured to determine a physical profile of the at least one person. The controller is configured to detect user-worn equipment on the at least one person.

Embodiments of the first aspect of the disclosure can include any one or a combination of the following features:
the end effector is a welding torch;
an audio system in communication with the controller, the audio system comprising a sound exciter;
the audio system includes a microphone and the controller is configured to detect audio from the microphone, and wherein the controller is configured to determine a vocal statement from the at least one person;
a window darkening system coupled to a plurality of vehicle windows, wherein the window darkening system is configured to reduce transmittance of the plurality of vehicle windows in response to the end effector being in the use condition;
the end effector further comprises a robotic arm;
the user-worn equipment comprises welding equipment;
the body comprises a vehicle cargo bed;
the controller is configured to communicate a signal to the end effector to change the end effector between the use condition and the non-use condition;
the controller is configured to communicate the signal to the end effector to change the end effector between the use condition and the non-use condition when the controller detects the user-worn equipment on the at least one person; and
the controller is configured to communicate a signal to the audio system to emit audio from the sound exciter, wherein the controller is configured to receive a signal from a microphone of the audio system and determine an audible response from the at least one person.

According to another aspect of the present disclosure, a vehicle-aided detection system for a vehicle includes a vehicle cargo bed. An end effector is coupled to the vehicle cargo bed and to a robotic arm. The end effector is movable in an operating environment. The end effector is operable between a use condition and a non-use condition. A sensor system is configured to detect the end effector and at least one person in the operating environment of the end effector. A controller processing information received from the sensor system. The controller is configured to determine a physical profile of the at least one person. The controller is configured to detect user-worn equipment on the at least one person. An audio system in communication with the controller.

Embodiments of the second aspect of the disclosure can include any one or a combination of the following features:
the audio system comprises a microphone and the controller is configured to detect audio from the microphone, and wherein the controller is configured to determine a vocal statement from the at least one person;
the audio system comprises a sound exciter;
the end effector is a welding torch, and wherein the user-worn equipment comprises welding equipment; and
the controller is configured to communicate a signal to the end effector to change the end effector between the use condition and the non-use condition when the controller detects the user-worn equipment on the at least one person.

According to another aspect of the present disclosure, a method of detecting and monitoring a vehicle-aided operation of a vehicle includes detecting whether an end effector is being powered by a vehicle. Then determining whether a person within an operating environment of the end effector is wearing user-worn equipment, and finally, deactivating the end effector based on a determination the person is not wearing the user-worn equipment.

Embodiments of the third aspect of the disclosure can include any one or a combination of the following features:
emitting audio to instruct the person to equip the user-worn equipment or to move outside of the operating environment;
the audio is emitted by a vehicle audio system; and
the vehicle audio system comprises a sound exciter.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a top view of a vehicle having a cargo bed with a robotic arm, end effector, and a vehicle-aided detection system, according to one example;

FIG. 2 is a rear perspective view of a vehicle having a cargo bed with a robotic arm, end effector, and a vehicle-aided detection system, according to one example;

FIG. 3 is a side view of a vehicle having a cargo bed with a robotic arm, end effector, and a vehicle-aided detection system, and a person wearing user-worn equipment, according to one example;

FIG. 4 is a block diagram illustrating a vehicle-aided detection system, having a sensor system, a controller, and various other vehicle systems, according to one embodiment; and

FIG. 5 is a flow diagram illustrating steps of a routine of the vehicle-aided detection system, according to one embodiment.

### DETAILED DESCRIPTION OF THE PREFERRED EMBODIMENTS

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

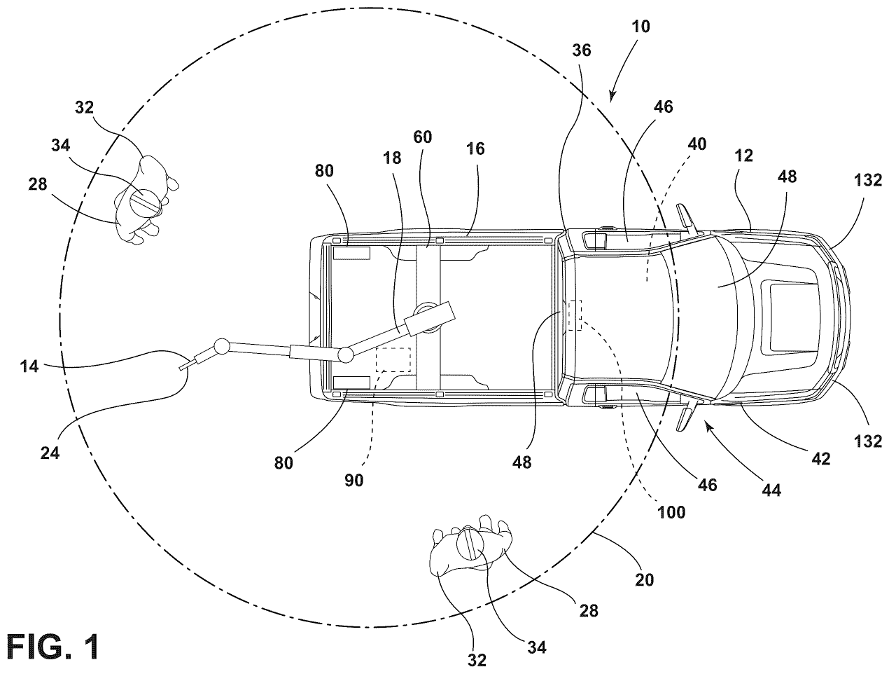

In reference to FIGS. 1-5, a vehicle-aided detection system 10 for a vehicle 12 is disclosed. The vehicle-aided detection system 10 may include an end effector 14 coupled to a vehicle cargo bed 16. The end effector 14 may be coupled to the vehicle cargo bed 16 via a robotic arm 18. The end effector 14 is movable in an operating environment 20 between a use condition 22 and a non-use condition 24. The vehicle-aided detection system 10 may include a sensor system 26 configured to detect the end effector 14 and at least one person 28 in the operating environment 20. A controller 30 may process information received from the sensor system 26 and may determine a physical profile 32 of the at least one person 28 and detect user-worn equipment 34 on the at least one person 28. An audio system 36 may also be in communication with the controller 30.

With reference to the embodiment shown in FIG. 1-3, the vehicle 12 is a pickup truck embodiment that is equipped with one embodiment of the vehicle-aided detection system 10 for monitoring and detecting the operating environment 20 of an end effector 14. The vehicle 12 is generally illustrated having a cabin interior 40 defined by a vehicle body 42, wherein the cabin interior 40 is for transporting passengers in the vehicle 12. As illustrated in FIGS. 1-3, the vehicle 12 may have the cargo bed 16 vehicle rearward of the cabin interior 40. In some embodiments, the cargo bed 16 may be an open cargo bed 16. In yet other configurations, the cargo bed 16 may further comprise a fifth wheel coupler coupled to a top-center portion of the cargo bed 16.

The vehicle 12 is equipped with a plurality of vehicle windows 44 disposed throughout the vehicle body 42. As illustrated in FIGS. 1-3, the vehicle 12 may include four side passenger windows 46, a windshield 48, and a rear window 50. The four side passenger windows 46 and the rear window 50 may be powered doors, such that each window 46,50 may open or close through actuation of a button and/or in response to a signal sent from the controller 30 that causes a window actuator to open or close each window 46, 50. In some embodiments, each window may be opened by the actuators in response to a routine run by the controller 30, as provided further herein.

Additionally, each of the windows 46, 50, and the windshield 48 may be coupled to a window darkening system 52. The window darkening system 52 may further comprise at least one panel coupled to each window 46, 50 and the windshield 48, and circuitry coupled to said panel. In some embodiments, the window darkening system 52 may selectively darken and reduce transmissity of each window by selectively darkening each panel through an electric current traveling in the circuitry and to an electrochromic element. In other embodiments, the window darkening system 52 is in communication with the controller 30 and may operably darken each panel depending on an output sent from the sensor system 26 to the controller 30 and an output from the controller 30 to the window darkening system 52. For example, the window darkening system 52 may darken select windows 46, 50 in response to the sensor system 26 detecting a welding operation. In yet other embodiments, the window darkening system 52 may include an opaque setting, wherein the opaque setting darkens the windows 46, 50 to an opaque setting that blocks the transmittance of light. For example, the window darkening system 52 may actuate the opaque setting during a welding operation to ensure that light emitted from the welding operation cannot be seen or is greatly lessened in brightness (i.e., luminosity) from inside the cabin interior 40. Additionally or alternatively, the window darkening system 52 may use a variety of means to selectively darken each window 46, 50 and the windshield 48, so long as transmissity may be selectively reduced.

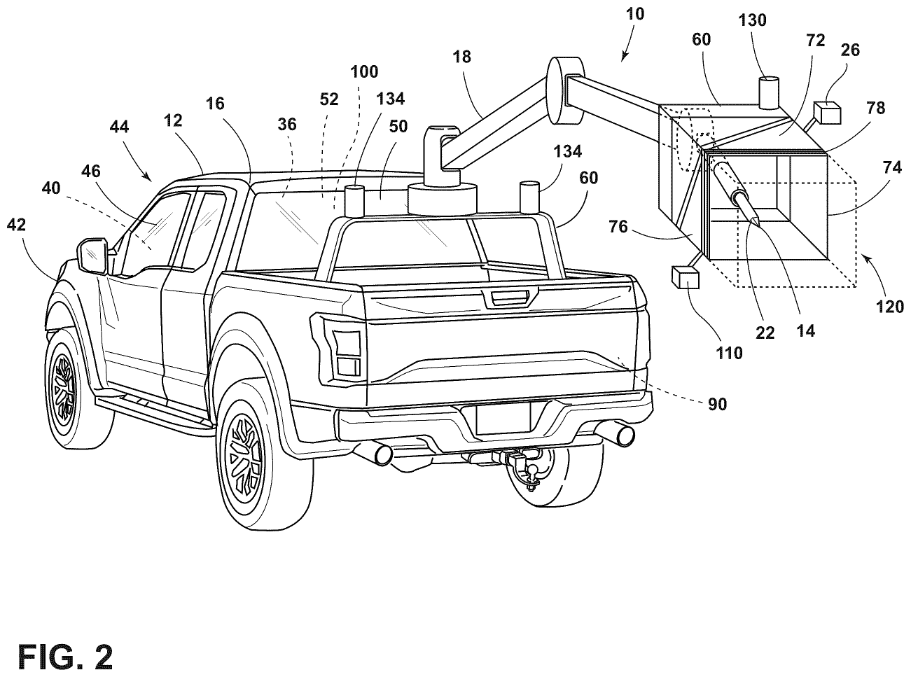

Referring to FIGS. 1-3, the robotic arm 18 may be coupled to a body 16 of the vehicle 12. In the illustrated embodiment, the body 16 comprises the cargo bed and the robotic arm 18 is coupled to the cargo bed 16. Further, the robotic arm 18 may be coupled to the cargo bed 16 via the fifth wheel coupler. In yet other embodiments, the robotic arm 18 may be coupled to the cargo bed 16 via a load beam 60 that extends perpendicular to the cargo bed 16, as illustrated in FIGS. 1-2. In particular, the robotic arm 18 may be coupled to the load beam 60 and the load beam 60 may be slideably coupled to the cargo bed 16 such that the robotic arm 18 may linearly translate along the length of the cargo bed 16 via the linear travel of the load beam 60. In this embodiment, the load beam 60 may be manually translated along the cargo bed 16 or driven via a driver motor.

Referring further to FIGS. 1-3, in various configurations, the robotic arm 18 may be any kind of various robotic arms and is configured to removably couple to the end effector 14 and permit movement of the end effector 14 towards a desired point. For example, the robotic arm 18 may be an articulated robot having five joints and five degrees of freedom, wherein the five joints and five degrees of freedom provide movement of a welding torch 14 towards and along a desired point. It is generally contemplated that the robotic arm 18 may be one of various kinds of robots and may have various number of joints, so long as the robotic arm 18 may permit movement of the end effector 14.

Referring to FIGS. 1-3, the vehicle-aided detection system 10 includes the end effector 14. In some embodiments, the end effector 14 is removably coupled to the robotic arm 18. In other embodiments, the end effector 14 may be removably disposed in an end effector housing 80. According to various embodiments, the vehicle-aided detection system 10 may include a plurality of end effectors 14. For example, a first end effector 14 may be removably coupled to the robotic arm 18, and a second end effector 14 and a third end effector 14 may be removably disposed in the end effector housing 80. In yet other embodiments, the end effector 14 may be coupled to the vehicle body 42 via a coupling means. For example, the end effector 14 may be a grinder coupled to the vehicle body 42 via a power cable.

According to some embodiments, the end effector ## may be any of various engagement devices and/or tools. For example, the end effector ## may be a screw driver, a hammer, a drill, a welding torch, and other manually powered devices. Further, the end effector ## may be an electrically or mechanically powered engagement device and/or tool, such as a screw driver, pneumatic grippers, a welding torch, a laser, a grinder, and other powered devices. It is also contemplated that the end effector may be one of other various devices.

The end effector 14 is operable between the use condition 22 and the non-use condition 24. In some embodiments, the end effector 14 may switch between the use condition 22 and the non-use condition 24 via a signal sent from the controller 30 to the auxiliary power system 90, as provided herein. The end effector 14 is configured to interact with a desired point and/or object. In various embodiments, the interaction between the end effector 14 and the object is used to complete a desired task. For example, an end effector 14 that is a welder may be configured to weld two proximate pieces of material together.

In various embodiments, the vehicle-aided detection system 10 includes an end effector shield 70 that is proximate the end effector 14. As illustrated in FIGS. 1-3, the end effector shield 70 may be coupled to an end portion of the robotic arm 18 and include a shield outer surface 72 and a shield inner surface 74, wherein the end effector shield inner surface 74 at least partially encloses the end effector 14. For example, the end effector 14 may be a welding torch 14 and the end effector shield 70 may be a welding shield having a generally rectangular shape, wherein the generally rectangular shape defines an inner surface 74 that partially encloses the welding torch 14. The end effector shield 70 may be configured to partially enclose the end effector 14 such that the interaction between the end effector 14 and an object is at least partially enclosed in the end effector shield 70. For example, the end effector 14 may be a welding torch and the end effector shield 70 may be an auto-darkening light shield configured to darken and reduce transmittance when the welding torch 14 is in use. Additionally or alternatively, it is generally contemplated that the end effector shield 70 may generally define various shapes and/or sizes, so long as the end effector shield 70 may at least partially enclose the end effector 14.

Further with respect to the end effector shield 70, in some variations, the end effector shield 70 may comprise multiple, retractable portions 76. In some embodiments, the end effector shield 70 may generally define a rectangular shape and have a first side portion 76a a second side portion 76 opposite the first side portion 76a, a third side portion 76 above the first and second side portions 76, and a fourth side portion 76 opposite the third side portion 76. The retractable portions 76 may be configured to selectively retract, via a drive means. In application, the retractable portions 76 retraction may be determined by the end effector 14 in use and the object being interacted with. For example, if a welding torch 14 is welding a top section of a circular pipe, a top side portion 76 of the end effector shield 70 may stay extended while side portions 76 and a bottom portion 76 of the end effector shield 70 are retracted.

Referring further to the end effector shield 70, a magnetic strip 78 may be disposed at an end of the end effector shield 70. The magnetic strip 78 may generally define a shape that coincides with a shape of the end effector shield 70. In the illustrated embodiment shown in FIG. 2, the end effector shield 70 defines a generally rectangular shape and the magnetic strip 78 likewise defines a generally rectangular shape. According to various embodiments, the magnetic strip 78 is configured to collect various magnetic debris during an interaction between the end effector shield 70 and an object. For example, the magnetic strip 78 may be configured to collect slag splattered during a welding operation by a welding torch 14.

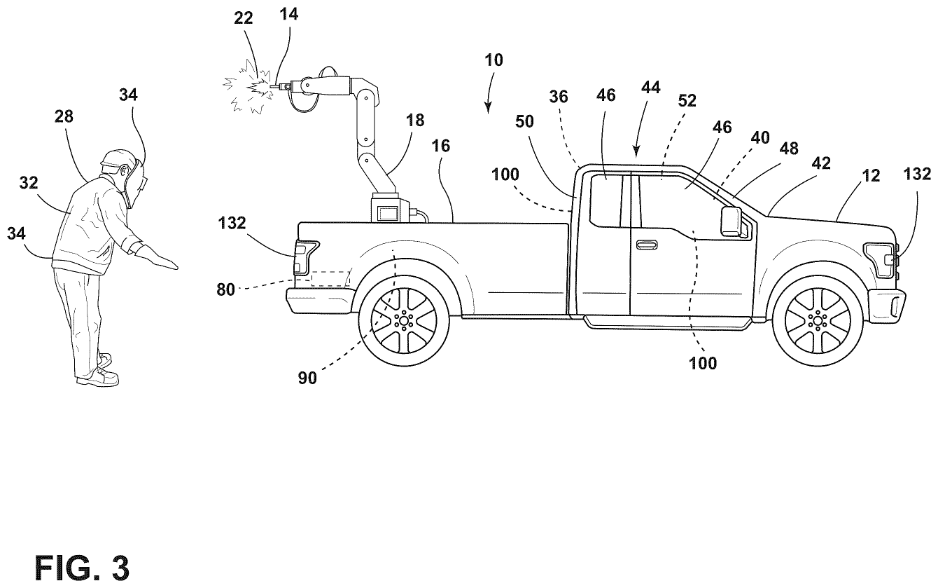

Referring to FIGS. 1, 3, the vehicle-aided detection system 10 may include an end effector housing 80. In some embodiments, the vehicle-aided detection system 10 may include a plurality of end effector housings 80. According to various configurations, the end effector housing 80 may be disposed in the vehicle body 42, such as the vehicle cargo bed 16. The end effector housing 80 may generally define any of various shapes, such as a generally rectangular shape, or a circular shape. The end effector housing 80 may be configured to removably receive and couple to the end effector 14. In some configurations, the end effector housing 80 may be configured to removably couple to a plurality of end effectors 14, such as the welding torch 14, or a grinder. Additionally, the end effector housing 80 may be configured to allow the robotic arm 18 and/or a person to approach the end effector housing 80, couple to or decouple from an end effector 14, and remove or place the end effector 14. Additionally, it is generally contemplated that the end effector housing 80 may be disposed in various locations in the vehicle body 42, so long as the robotic arm 18 and/or a person 28 may approach the end effector housing 80 and retrieve or dispose of an end effector 14 into the end effector housing 80.

Referring to FIGS. 1 and 3-4, the vehicle-aided detection system 10 includes the auxiliary power system 90 disposed within the vehicle 12. In various embodiments, the auxiliary power system 90 may be disposed within the rear of the vehicle 12 and be accessible via at least one outlet defined on the vehicle cargo bed 16. In yet other embodiments, the auxiliary power system 90 may be in communication with the controller 30, such that the controller 30 may send a signal that can cycle electric power to the auxiliary power system 90. The auxiliary power system 90 may be coupled to the robotic arm 18, load beam 60, and end effector 14. According to various embodiments, the auxiliary power system 90 is configured to selectively provide electric power to the end effector 14, end effector shield 70, robotic arm 18, and load beam 60. For example, the auxiliary power system 90 may supply electric power to an electric welding torch 14, a welding shield 70 and an articulated robotic welding arm 18.

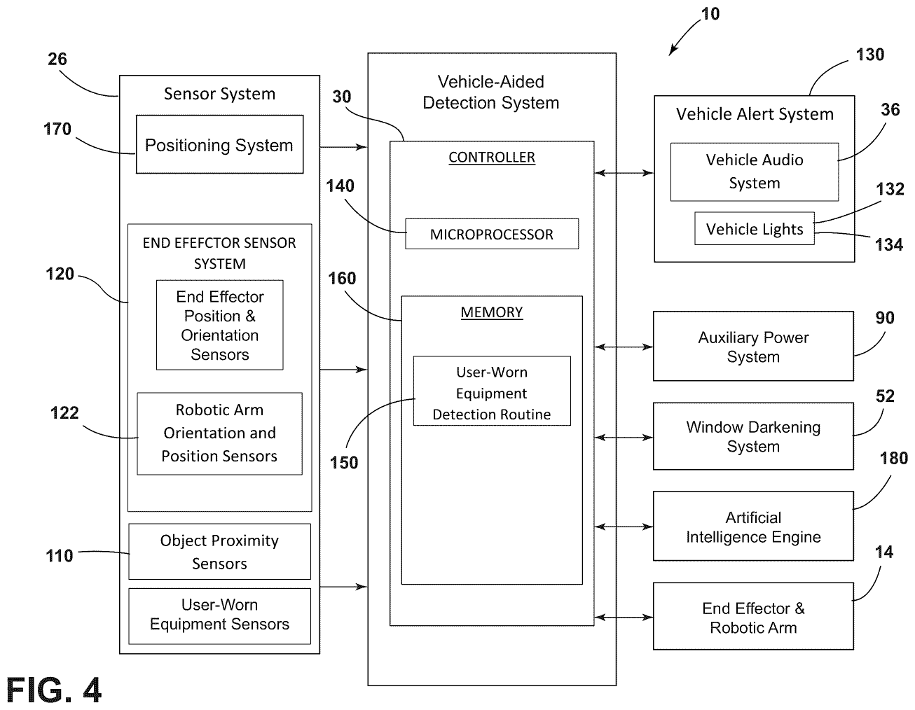

Referring to FIGS. 4, the vehicle-aided detection system 10 includes the audio system 36. In some embodiments, the audio system 36 comprises at least one sound exciter 100 coupled to a portion of the vehicle 12. For example, the audio system 36 may comprise a first sound exciter 100 coupled to the first side passenger window 46, a second sound exciter 100 coupled to the second side passenger window 46, and a third sound exciter 100 coupled to the rear window 50. In some embodiments, the audio system 36 is configured to receive inputs from the controller 30 and output audible sound after receiving an input from the controller 30.

Referring to FIGS. 4, the vehicle-aided detection system 10 may include a sensor system 26. In some embodiments, the sensor system 26 includes a plurality of sensors that are configured to detect objects in the proximity of the vehicle 12 and that may be in the operating environment 20 of the end effector 14. The plurality of sensors may include one or a combination of visual sensors (e.g., cameras, surround view cameras, etc.), radar sensors, Lidar sensors, ultrasonic sensors, lasers, thermal sensors, and/or various other sensors. For example, in some embodiments, the vehicle 12 may include ultrasonic sensors, surround view cameras, radar sensors disposed on the corners and front of the vehicle 12, and a camera on the front and the rear of the vehicle 12. It is contemplated that the plurality of sensors in the sensor system 26 may be located in various positions on the vehicle 12. It is further contemplated that, in some embodiments, one or more of the plurality of sensors may be coupled to the end effector 14 and robotic arm 18, in addition to one or more sensors coupled to the vehicle 12. The sensor system 26 may be configured to provide sensed inputs to the controller 30. In various embodiments, the data collected from the plurality of sensors in the sensor system 26 may be utilized to determine the operating environment 20 of the end effector 14. In yet other embodiments, the operating environment 20 of the end effector 14 may be predefined by the end effector 14 in use, as provided herein. In some variations, the data collected from the plurality of sensors in the sensor system 26 may be utilized by the controller 30 to map the features detected within the operating environment 20. The features detected within the operating environment 20 of the end effector 14 may include, but are not limited to, the vehicle 12, the end effector 14, the end effector shield 70, the robotic arm 18, persons 28, and user-worn equipment 34, as well as other moving and stationary objects within the operating environment 20 and within a prescribed distance of the operating environment 20.

With respect to determining the position of the vehicle 12, in some embodiments, the vehicle-aided detection system 10 may receive vehicle 12 status-related information from additional sensors and devices. The information may include positioning information from a positioning system 170, which may include a global positioning system (GPS) on the vehicle 12 and/or a dead reckoning system, to determine a coordinate location of the vehicle 12 based on the location of the positioning device. Other vehicle 12 information received by the vehicle-aided detection system 10 may include a speed reading from a speed sensor and a yaw rate from a yaw sensor.

Further still, with respect to detecting potential objects, in some embodiments, the sensor system 26 may include an object proximity sensor 110 that provides the proximity of an object to the controller 30 of the vehicle-aided detection system 10. More specifically, the object proximity sensor 110 may provide the vehicle-aided detection system 10 with proximity information of the object, which may include information estimating a location of the object or objects relative to the vehicle 12 and/or end effector 14. The object proximity sensor 110 may include an individual sensor, multiple sensors, and various combinations of sensors and sensor systems to capture, generate, and output information characterizing the proximity of the object adjacent to the vehicle 12 and/or end effector 14, as described in more detail herein. Accordingly, the object proximity sensor 110 may include portions of or be incorporated with the positioning system 170, the end effector sensor system 120, or other additional sensors and devices. The vehicle-aided detection system 10 may use the proximity information of the object or objects as an input to the controller 30 to inform a person 28 of an operation being conducted by the end effector 14, to prevent a person seeing an operation being conducted by the end effector 14, and/or to instruct a person 28 to equip appropriate user-worn equipment 34, as provided further herein.

Referring to FIG. 4, the sensor system 26 may include an end effector sensor system 120. The end effector sensor system 120 includes a plurality of sensors that are configured to detect information pertinent to the end effector 14 and communicate said information to the controller 30. In particular, the end effector sensor system 120 may detect a position of the end effector 14, a speed and rotational movement of the end effector 14, a force exerted by the end effector 14, light and/or sound proximate the end effector 14, the type of end effector 14 in use, the location of various end effectors 14 in the end effector housing 80, and the distance between the end effector 14 and an object. Additionally, the end effector sensor system 120 may comprise robotic arm orientation and position sensors 122 coupled to the robotic arm 18, the plurality of sensors 18 providing a speed, rotational movement, length, and other various parameters of the robotic arm 18. In some variations, the data collected from the plurality of sensors in the end effector sensor system 120 may be utilized by the controller 30 to at least partially define the operating environment 20, the type of end effector 14 being used, and the proper routine 150 to run, as well as to detect people 28 within the operating environment 20. For example, the controller 30, via the data collected from the end effector sensor system 120, may determine that the end effector 14 is a welding torch, that welding is being conducted, and that a routine pertinent to welding should be conducted, as provided herein.

With respect to determining the position of the end effector 14, in some embodiments, the vehicle-aided detection system 10 may receive end effector 14 status-related information from additional sensors and devices. The information may include sensor information from the sensor system 26, positioning information from a positioning system 170, which may include the global positioning system (GPS) and/or dead reckoning system, to determine a coordinate location of the end effector 14 based on the location of the positioning device.

With reference to FIG. 4, the vehicle-aided detection system 10 in the illustrated embodiment may communicate with one or more devices, include a vehicle alert system 130, which may prompt visual, auditory, and/or tactile signals. For instance, vehicle lights 132, such as light beacons 134 coupled to the load beam 60, brake lights, or vehicle emergency flashers may provide a visual alert and the audio system 36 may provide an audible alert via a car horn, car speaker, or at least one sound exciter 100. By way of example, the vehicle alert system 130 may prompt the beacons 134 to emit a flashing light during a welding procedure and an audible siren during the welding procedure. Additionally, the vehicle-aided detection system 10 may communicate with a vehicle microphone of the audio system 36. For example, the vehicle-aided detection system 10 may prompt a user to respond to the vehicle-aided detection system 10, wherein the audio system 36 gives the auditory message and receives the auditory response through the vehicle microphone.

As further illustrated in FIG. 4, the controller 30 is configured with a microprocessor 140 to process logic and a routine 150 stored in memory 160 that receive information from the sensor system 26 the end effector sensor system 120, the robotic arm orientation and position sensors 122, the object proximity sensors 110, the vehicle alert system 130, the auxiliary power system 90, and the window darkening system 52. The controller 30 may generate audio or visual statements, as well as end effector 14 and vehicle 12 information and commands as a function of all or a portion of the information received. Thereafter, the end effector 14 and vehicle 12 information and commands may be provided to the vehicle alert system 130, auxiliary power system 90, and window darkening system 52 to prevent an end effector 14 operation occurring when a person 28 without proper user-worn equipment 34 is in the operating environment 20 of the end effector 14, inhibit improper viewing of the end effector 14 operation, and/or modify the end effector 14 operation to prevent the entrance of people 28 into the operating environment 20 and/or prevent the viewership of the end effector 14 operation. Additionally, the controller 30 may be configured to prompt one or more vehicle systems (e.g., vehicle alert system 130, auxiliary power system 90) to execute one or more end effector 14 measures, as will be discussed in more detail below.

The controller may include a microprocessor 140 as shown, and/or other analog and/or digital circuitry for processing one or more routines. Also, the controller 30 may include the memory 160 for storing one or more routines, including a user-worn equipment detection routine 150. It should be appreciated that the controller 30 may be a stand-alone dedicated controller or may be a shared controller integrated with other control functions, such as integrated with the sensor system 26 and other conceivable onboard or off-board vehicle control systems.

Referring further to FIG. 4, the controller 30 is configured with the microprocessor 140 to process logic and routines stored in memory 160 that receive information from the above-described sensors and vehicle systems, including, but not limited to, the imaging system, the auxiliary power system 90, the sensor system 26, an artificial intelligence engine 180, the vehicle alert system 130, and other vehicle sensors and devices.

Referring back to FIG. 1, the controller 30 may define the operating environment 20. In some embodiments, the operating environment 20 may be generally defined as a circular area in which the end effector 14 is in use, as illustrated in FIG. 1. In yet other embodiments, the operating environment 20 may generally be defined by an oval or rectangular area. It is generally contemplated that the operating environment 20 may generally encompass one of various areas defining a particular shape. The controller 30 may generate the operating environment 20 via data obtained from the sensor system 26 and from the end effector 14 in use. For example, if the sensor system 26 indicates that a continuous welding operation is ongoing and a welding torch 14 is in use, the controller 30 may generate an operating environment 20 suitable for a welding operation. In another embodiment, the controller 30 may generate a pre-defined operating environment 20 based on the action chosen. In yet another embodiment, the controller 30 may generate an operating environment 20 that includes the cabin interior 40.

Referring to FIGS. 1 and 3, the controller 30 may detect an object and generate a physical profile 32 of a person 28 after detection of the object. In some embodiments, the controller 30 may detect the object and generate the physical profile 32 from data obtained via the sensor system 26. In yet other embodiments, the controller 30 may detect the object and generate a physical profile 32 once the object is within the operating environment 20 or within a prescribed distance of the operating environment 20. For example, the controller 30 may receive data from a plurality of imaging sensors (e.g., a camera), cabin interior sensors and object proximity sensors 110 that detect an object in the operating environment 20, and run a routine 150 that detects the object and then determines the object is a person 28. Next, the controller 30 classify the person 28 by generating the physical profile 32 of the person 28 via the routine 150, wherein the generation and classification through the physical profile 32 may be dictated by an attribute of the person ##. For example, the physical profile 28 may be determined by a height, width, gait, limb length of the person 28, and/or by apparel worn and/or by an object held by the person 28. Additionally, the controller 30 may likewise detect multiple people 28 and generate multiple physical profiles 32. For example, the controller 30 may generate a first and second physical profile 32 for two people 28 in the operating environment 20, and a third physical profile 32 for a person 28 in the cabin interior 40.

Referring to FIGS. 1 and 3, the controller 30 may detect user-worn equipment 34 on a person 28. In some embodiments, the controller 30 may detect user-worn equipment 34 via the physical profile 32. In particular, the controller 30 may run the routine 150 and detect the user-worn equipment 34 on the person 28 by analyzing the physical profile 32 and determining if any user-equipment is present. In some embodiments, the controller 30 may reference a database of pre-defined user-worn equipment 34 when making a determination to define what is user-worn equipment 34, wherein the controller 30, via the database, provides expected user-worn equipment 34 depending on the end effector 14 in use. For example, if the end effector 14 is a welding torch, the controller 30 may define user-worn equipment 34 as welding equipment that includes a welding face shield and a welding jacket. In yet other embodiments, the controller 30, may utilize a machine learning model to determine if user-worn equipment 34 is worn by the person 28. Upon a determination of whether user-worn equipment 34 is present, the controller 30 may send an output to one of the various vehicle 12 systems, as provided herein.

The vehicle 12 and end effector 14 information and parameters may be used to determine a position and operation based relationship between the vehicle 12 and the end effector 14 for use in the routine 150. This position and operation based relationship may be useful in determining what the operating environment 20 may be and whether objects, such as a person 28 and user-worn equipment 34, are within the operating environment 20 of the end effector 14, such that a detection and determination of user-worn equipment 34 on the person 28 may be conducted. In describing the position and operation based relationship, certain assumptions may be made with regard to parameters associated with the vehicle 12 and the end effector 14. Examples of such assumptions include, but are not limited to, type of vehicle 12, length of the robotic arm 18, and reach of the end effector 14.

With respect to the general operation of the vehicle-aided detection system 10, as illustrated in the system diagram of FIG. 4, the vehicle-aided detection system 10 includes various other sensors and devices that obtain or otherwise provide vehicle 12 status-related information. This information includes positioning information from a positioning system 170, which may include a dead reckoning device, or, in addition or as an alternative, a global positioning system (GPS), to determine a coordinate location of the vehicle 12 based on the one or more locations of the devices within the positioning system 170. In particular, the positioning system 170 may output data to the controller 30, wherein the data can at least partially determine the operating environment 20 of the robotic arm 18.

Referring to FIG. 4, the controller 30 may be in communication with the artificial intelligence engine 180. In some embodiments, the artificial intelligence engine 180 is configured to generate machine learning models. In some embodiments, the generated machine learning models may be utilized by the controller 30 in analyzing the sensor data provided by the sensor system 26 to the controller 30. For example, the machine learning models may be used in analyzing image data and determining a physical profile 32 of one or more persons 28.

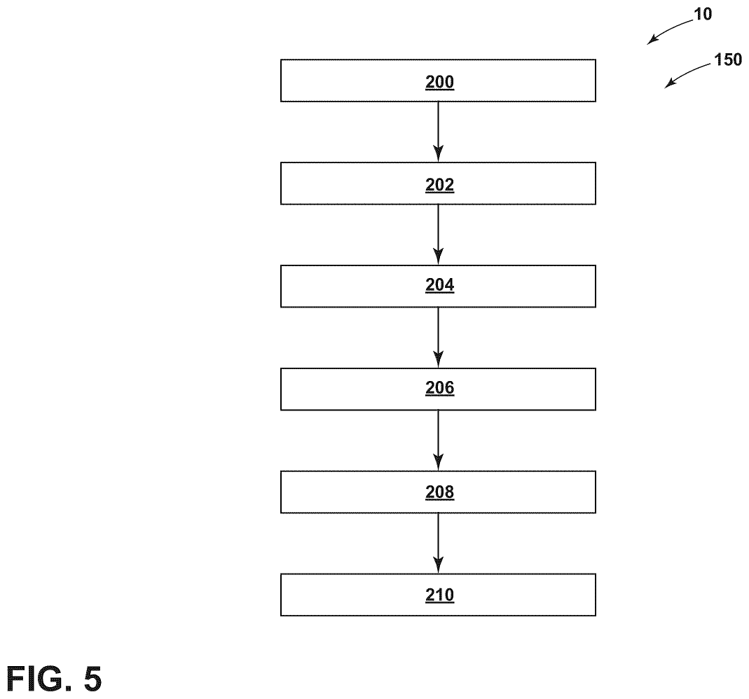

Referring now to FIG. 5, an embodiment of the routine 150 for use in the vehicle-aided detection system 10 is illustrated. In the illustrated embodiment, the routine 150 begins in step 200 by receiving signals from the sensor system 26 of the vehicle 12. These signals may pertain to parameters and conditions relating to the vehicle-aided detection system 10, in particular, the vehicle 12, the end effector 14, the robotic arm 18, the auxiliary power source 90, the window darkening system 52, etc.

At step 202 the received signals may be utilized to estimate various vehicle 12 and/or end effector 14 parameters. For example, the receiving signals may be used to determined if the end effector 14 is in the use-condition and to estimate the type of end effector 14 in use, and the length and mobility of the robotic arm 18, and the size and placement of the operating environment 20. It is contemplated that in some examples, other vehicle 12 and/or end effector 14 parameters may be estimated.

At step 204, the vehicle-aided detection system 10 may determine the operating environment 20 of the end effector 14. Next, at step 200, the vehicle-aided detection system 10 may then determine what user-worn equipment 34 coincides with the end effector 14 in-use. At step 206, the vehicle-aided detection system 10 may then determine if one or more persons 28 are near the operating environment 20, within the operating environment 20 of the end effector 14, or whether one or more persons 28 are inside the cabin interior 40.

Next, at step 208, the controller 30 determines whether the one or more persons 28 within the operating environment 20 are equipped with the user-worn equipment 34 and whether the window darkening system 52 is required for the one or more persons 28 within the cabin interior 40 In some embodiments, the controller 30 is configured to determine whether the one or more persons 28 are wearing user-worn equipment 34 via sensor readings from the sensor system 26. For example, the controller 30 may determine that user-worn equipment 34 is undetected through imaging sensor data. In yet other embodiments, the controller 30 may determine whether user-worn equipment is worn by outputting a message via the audio system 36, asking for user-confirmation. The controller 30 may then receive and determine that the at least one person 28 either is or is not wearing the user-worn equipment via an input from a microphone of the audio system 36. According to yet other embodiments, the controller 30 may determine whether user-worn equipment is worn via an output from at least one sensor disposed on the user-worn equipment 34. For example, a sensor may be disposed on a welding mask, indicated if the mask is in a use position or non-use position.

If the controller 30 determines that one or more persons 28 are not wearing the user-worn equipment 34, the controller 30 will output a response in step 210. In some embodiments, the controller 30 may send a signal to the audio system 36, eliciting a message via at least one sound exciter 100, that the one or more persons 28 needs to either leave the operating environment 20 or equip the user-worn equipment 34. Thereafter, the controller 30 may then return to step 208 and determine if the one or more persons 28 are within the operating environment 20 and are wearing the user-worn equipment 34. In yet other embodiments, the controller 30 may send a signal to the auxiliary power system 90 and cut power to the end effector 14 while one or more persons 28 are detected within the operating environment 20 without the user-worn equipment 34.

Referring further to step 210, in some embodiments, the controller's 30 outputted response may comprise sending a signal to the window darkening system 52. For example, if the controller 30 determines in step 202 that a welding torch is in use and that one or more persons 28 are present in the cabin interior 40 in step 206, and that at least one person's field of view is within the operating environment 20 of the welding torch 14, the controller 30 may send an output to the window darkening system 52, selectively darkening the vehicle windows 44, 46, 44, 50. In various embodiments, the vehicle-aided detection system 10 may then return to step 200 after the completion of step 210.

The present disclosure may provide for a variety of advantages. For example, operation of the vehicle-aided detection system 10 enables the controller 30 to detect one or more persons 28 approaching an operating environment 20 before a task is conducted and while a task is conducted. Additionally, operation of the vehicle-aided detection system 10 enables the controller 30 to then detect and inform the operator and the one or more persons 28 that they are entering the operating environment 20 and that select user-worn equipment 34 required. Further, in certain situations, operation of the vehicle-aided detection system 10 may enable the controller 30 to prompt various other vehicle systems, such as the audio system 36, the auxiliary power system 90, etc., to actively adjust vehicle 12 and end effector 14 parameters, depending on the end effector 14 in use. For example, the controller 30 may prompt the window darkening system 52 to reduce transmittance of the vehicle windows 44, 46, 48, 50 while a welding torch 14 is in use.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle-aided detection system for a vehicle, comprising:
a body;
an end effector coupled to the body, the end effector being movable in an operating environment, wherein the end effector is operable between a use condition and a non-use condition;
a sensor system configured to detect the end effector and at least one person in the operating environment of the end effector; and
a controller processing information received from the sensor system, wherein the controller is configured to determine a physical profile of the at least one person, and wherein the controller is configured to detect user-worn equipment on the at least one person.

2. The vehicle-aided detection system of claim 1, wherein the end effector is a welding torch.

3. The vehicle-aided detection system of claim 1, further comprising an audio system in communication with the controller, the audio system comprising a sound exciter.

4. The vehicle-aided detection system of claim 3, wherein the audio system comprises a microphone and the controller is configured to detect audio from the microphone, and wherein the controller is configured to determine a vocal statement from the at least one person.

5. The vehicle-aided detection system of claim 1, further comprising a window darkening system coupled to a plurality of vehicle windows, wherein the window darkening system is configured to reduce transmittance of the plurality of vehicle windows in response to the end effector being in the use condition.

6. The vehicle-aided detection system of claim 1, wherein the end effector further comprises a robotic arm.

7. The vehicle-aided detection system of claim 1, wherein the user-worn equipment comprises welding equipment.

8. The vehicle-aided detection system of claim 1, wherein the body comprises a vehicle cargo bed.

9. The vehicle-aided detection system of claim 1, wherein the controller is configured to communicate a signal to the end effector to change the end effector between the use condition and the non-use condition.

10. The vehicle-aided detection system of claim 9, wherein the controller is configured to communicate the signal to the end effector to change the end effector between the use condition and the non-use condition when the controller detects the user-worn equipment on the at least one person.

11. The vehicle aided-detection system of claim 3, wherein the controller is configured to communicate a signal to the audio system to emit audio from the sound exciter, and wherein the controller is configured to receive a signal from a microphone of the audio system and determine an audible response from the at least one person.

12. A vehicle-aided detection system for a vehicle, comprising:
a vehicle cargo bed;
an end effector coupled to the vehicle cargo bed, the end effector being coupled to a robotic arm, wherein the end effector is movable in an operating environment, and wherein the end effector is operable between a use condition and a non-use condition;
a sensor system configured to detect the end effector and at least one person in the operating environment of the end effector;
a controller processing information received from the sensor system, wherein the controller is configured to determine a physical profile of the at least one person, and wherein the controller is configured to detect user-worn equipment on the at least one person; and
an audio system in communication with the controller.

13. The vehicle-aided detection system of claim 12, wherein the audio system comprises a microphone and the controller is configured to detect audio from the microphone, and wherein the controller is configured to determine a vocal statement from the at least one person.

14. The vehicle-aided detection system of claim 13, wherein the audio system comprises a sound exciter.

15. The vehicle-aided detection system of claim 12, wherein the end effector is a welding torch, and wherein the user-worn equipment comprises welding equipment.

16. The vehicle-aided detection system of claim 12, wherein the controller is configured to communicate a signal to the end effector to change the end effector between the use condition and the non-use condition when the controller detects the user-worn equipment on the at least one person.

17. A method of detecting and monitoring a vehicle-aided operation, comprising:
detecting whether an end effector is being powered by a vehicle;
determining whether a person within an operating environment of the end effector is wearing user-worn equipment; and
deactivating the end effector based on a determination the person is not wearing the user-worn equipment.

18. The method of claim 17, further comprises emitting audio to instruct the person to equip the user-worn equipment or to move outside of the operating environment.

19. The method of claim 18, wherein the audio is emitted by a vehicle audio system.

20. The method of claim 17, wherein the vehicle audio system comprises a sound exciter.
